(19) United States
(12) Patent Application Publication
(10) Pub. No.: US 2021/0111796 A1
(43) Pub. Date: Apr. 15, 2021

(54) PON POWER METER AND OPTICAL NETWORK UNIT OPERATING STATE IDENTIFICATION

(71) Applicant: Nokia Technologies OY, Espoo (FI)

(72) Inventors: Joseph SMITH, Fuquay-Varina, NC (US); Roy TEBBE, Raleigh, NC (US)

(73) Assignee: Nokia Technologies OY, Espoo (FI)

(21) Appl. No.: 16/801,618

(22) Filed: Feb. 26, 2020

Related U.S. Application Data
(60) Provisional application No. 62/913,898, filed on Oct. 11, 2019.

(51) Int. Cl. H04B 10/079; H04B 10/27; H04B 10/564; H04B 10/54; H04Q 11/00

(52) U.S. Cl. CPC H04B 10/07955; H04B 10/27; H04B 10/25; H04B 10/541; H04Q 11/0067; H04B 10/564

(57) ABSTRACT

A passive optical network power meter includes at least one memory and the computer program code configured to, with at least one processor, cause the passive optical network power meter to: determine an extinction ratio for the optical network unit based on a first plurality of consecutive optical transmissions indicative of a first logic value during a first time interval and a second plurality of consecutive optical transmissions indicative of a second logic value during a second time interval, the second time interval being subsequent to the first time interval; detect an average transmit power for the optical network unit based on a third plurality of consecutive optical transmissions during a third time interval, the third plurality of consecutive optical transmissions indicative of alternating first and second logic values; and identify an operating state of the optical network unit based on the extinction ratio and the average transmit power.

### CROSS-REFERENCE TO RELATED APPLICATION(S)

This application claims priority under 35 U.S.C. § 119 to U.S. Provisional Application No. 62/913,898, filed on Oct. 11, 2019, the entire contents of which are incorporated herein by reference.

### TECHNICAL FIELD

One or more example embodiments relate to passive optical networks (PONs).

### BACKGROUND

A passive optical network (PON) is a type of fiber-optic access network. A PON may include an optical line terminal (OLT) at a central office (CO) and a number of optical network units (ONUs), also known as optical network terminals (ONTs), located at or near subscribers' premises (e.g., home, office building, etc.)

During operation of a PON, a continuous data stream may be transmitted downstream from the OLT to various ones of the ONUs, or transmitted upstream as bursts of data from various ones of the ONUs to the OLT.

### SUMMARY

The scope of protection sought for various example embodiments is set out by the independent claims. The example embodiments and features, if any, described in this specification that do not fall under the scope of the independent claims are to be interpreted as examples useful for understanding various example embodiments described herein.

At least one example embodiment provides a method of determining an operating state of an optical network unit, the method comprising: determining, at a passive optical network power meter, an extinction ratio for the optical network unit based on a first plurality of consecutive optical transmissions indicative of a first logic value during a first time interval and a second plurality of consecutive optical transmissions indicative of a second logic value during a second time interval, the second time interval being subsequent to the first time interval; detecting, at the passive optical network power meter, an average transmit power for the optical network unit based on a third plurality of consecutive optical transmissions during a third time interval, the third plurality of consecutive optical transmissions indicative of alternating first and second logic values; and identifying, at the passive optical network power meter, an operating state of the optical network unit based on the extinction ratio and the average transmit power.

At least one other example embodiment provides a non-transitory computer-readable storage medium storing computer-readable instructions that, when executed by at least one processor, cause a passive optical network power meter to perform a method of determining an operating state of an optical network unit, the method comprising: determining an extinction ratio for the optical network unit based on a first plurality of consecutive optical transmissions indicative of a first logic value during a first time interval and a second plurality of consecutive optical transmissions indicative of a second logic value during a second time interval, the second time interval being subsequent to the first time interval; detecting an average transmit power for the optical network unit based on a third plurality of consecutive optical transmissions during a third time interval, the third plurality of consecutive optical transmissions indicative of alternating first and second logic values; and identifying an operating state of the optical network unit based on the extinction ratio and the average transmit power.

According to one or more example embodiments, the operating state of the optical network unit may be one of compliant or non-compliant relative to standard operating parameters associated with the optical network unit.

The standard operating parameters may include a maximum optical modulation amplitude threshold value and a minimum optical modulation amplitude threshold value for the optical network unit. The method may further include: computing an optical modulation amplitude value for the optical network unit based on the extinction ratio and the average transmit power; and wherein the identifying identifies the operating state of the optical network unit based on the optical modulation amplitude value, the minimum optical modulation amplitude threshold value and the maximum optical modulation amplitude threshold value.

The identifying may identify the operating state of the optical network unit based on whether the optical modulation amplitude value is between the minimum optical modulation amplitude threshold value and the maximum optical modulation amplitude threshold value.

The determining, the detecting and the identifying may be performed at the time of installation of the optical network unit at a subscriber premises.

The first time interval may temporally spaced apart from the second time interval by a fourth time interval; and the method may further include receiving a NO POWER transmission at the passive optical network power meter during the fourth time interval.

The method may further include isolating, by the passive optical network power meter, the optical network unit from a passive optical network in the upstream direction. The isolating may include: directing the first plurality of consecutive optical transmissions from the optical network unit to an optical signal level meter; measuring a first transmit power of the first plurality of consecutive optical transmissions from the optical network unit; directing the second plurality of consecutive optical transmissions from the optical network unit to the optical signal level meter; measuring a second transmit power of the second plurality of consecutive optical transmissions from the optical network unit; directing the third plurality of consecutive optical transmissions from the optical network unit to the optical signal level meter for detecting the average transmit power for the optical network unit; and wherein the determining determines the extinction ratio based on the first transmit power and the second transmit power.

At least one other example embodiment provides a passive optical network power meter comprising at least one processor and at least one memory including computer program code. The at least one memory and the computer program code are configured to, with the at least one processor, cause the passive optical network power meter to: determine an extinction ratio for an optical network unit based on a first plurality of consecutive optical transmissions indicative of a first logic value during a first time interval and a second plurality of consecutive optical transmissions indicative of a second logic value during a second time interval, the second time interval being subsequent to the first time interval; detect an average transmit power for the optical network unit based on a third plurality of consecutive optical transmissions during a third time interval, the third plurality of consecutive optical transmissions indicative of alternating first and second logic values; and identify an operating state of the optical network unit based on the extinction ratio and the average transmit power.

The operating state of the optical network unit may be one of compliant or non-compliant relative to standard operating parameters associated with the optical network unit; the standard operating parameters may include at least a maximum optical modulation amplitude threshold value and a minimum optical modulation amplitude threshold value for the optical network unit; and the at least one memory and the computer program code may be configured to, with the at least one processor, cause the passive optical network power meter to compute an optical modulation amplitude value for the optical network unit based on the extinction ratio and the average transmit power, and identify the operating state of the optical network unit based on the optical modulation amplitude value, the minimum optical modulation amplitude threshold value and the maximum optical modulation amplitude threshold value.

The at least one memory and the computer program code may be configured to, with the at least one processor, cause the passive optical network power meter to identify the operating state of the optical network unit based on whether the optical modulation amplitude value is between the minimum optical modulation amplitude threshold value and the maximum optical modulation amplitude threshold value.

The passive optical network power meter may further include an optical switch configured to isolate the optical network unit from a passive optical network in the upstream direction.

The passive optical network power meter may further include: an optical signal level meter configured to measure a first transmit power of the first plurality of consecutive optical transmissions, a second transmit power of the second plurality of consecutive optical transmissions, and to detect the average transmit power for the optical network unit; wherein the optical switch is configured to direct the first plurality of consecutive optical transmissions, the second plurality of consecutive optical transmissions and the third plurality of consecutive optical transmissions to the optical signal level meter, and the at least one memory and the computer program code are configured to, with the at least one processor, cause the passive optical network power meter to determine the extinction ratio based on the first transmit power and the second transmit power.

The passive optical network power meter may be configured to operate in a passive mode and an isolation mode; and the passive optical network power meter may include an optical switch configured to pass transmission signals from the optical network unit in the upstream direction when in the passive mode, and block transmission signals from the optical network unit in the upstream direction when in the isolation mode.

At least one example embodiment provides a passive optical network power meter comprising: means for determining an extinction ratio for an optical network unit based on a first plurality of consecutive optical transmissions indicative of a first logic value during a first time interval and a second plurality of consecutive optical transmissions indicative of a second logic value during a second time interval, the second time interval being subsequent to the first time interval; means for detecting an average transmit power for the optical network unit based on a third plurality of consecutive optical transmissions during a third time interval, the third plurality of consecutive optical transmissions indicative of alternating first and second logic values; and means for identifying an operating state of the optical network unit based on the extinction ratio and the average transmit power.

According to one or more example embodiments, the operating state of the optical network unit may be one of compliant or non-compliant relative to standard operating parameters associated with the optical network unit.

The standard operating parameters may include a maximum optical modulation amplitude threshold value and a minimum optical modulation amplitude threshold value for the optical network unit. The passive optical network power meter may further include: means for computing an optical modulation amplitude value for the optical network unit based on the extinction ratio and the average transmit power; and wherein the means for identifying identifies the operating state of the optical network unit based on the optical modulation amplitude value, the minimum optical modulation amplitude threshold value and the maximum optical modulation amplitude threshold value.

The means for identifying may identify the operating state of the optical network unit based on whether the optical modulation amplitude value is between the minimum optical modulation amplitude threshold value and the maximum optical modulation amplitude threshold value.

The passive optical network power meter may further include means for isolating the optical network unit from a passive optical network in the upstream direction. The means for isolating may include: means for directing the first plurality of consecutive optical transmissions from the optical network unit to an optical signal level meter; means for measuring a first transmit power of the first plurality of consecutive optical transmissions from the optical network unit; means for directing the second plurality of consecutive optical transmissions from the optical network unit to the optical signal level meter; means for measuring a second transmit power of the second plurality of consecutive optical transmissions from the optical network unit; means for directing the third plurality of consecutive optical transmissions from the optical network unit to the optical signal level meter for detecting the average transmit power for the optical network unit; and wherein the means for determining determines the extinction ratio based on the first transmit power and the second transmit power.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a block diagram illustrating an example Passive Optical Network (PON).

FIG. 2 is a block diagram illustrating an Optical Line Terminal (OLT) according to example embodiments.

FIG. 3 is a block diagram illustrating an Optical Network Unit (ONU) according to example embodiments.

FIG. 4 is a hybrid signal flow diagram and flow chart illustrating a method according to example embodiments.

FIG. 5 is a block diagram illustrating a PON power meter (PPM) according to example embodiments.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

While one or more example embodiments may be described from the perspective of an optical line terminal (OLT), optical network unit (ONU) (also referred to as an optical network terminal (ONT)) or passive optical network (PON) power meter (PPM), it should be understood that one or more example embodiments discussed herein may be performed by one or more components (e.g., one or more processors or processing circuitry, optical switches, optical signal level meters, transceivers, etc.) at the applicable device or apparatus. For example, according to one or more example embodiments, at least one memory may include or store computer program code, and the at least one memory and the computer program code may be configured to, with at least one processor, cause the OLT, ONU or PPM to perform the operations discussed herein.

It will be appreciated that a number of example embodiments may be used in combination.

One or more example embodiments provide mechanisms for identifying an operating state of an ONU in a PON based on an extinction ratio (ER) and a measured average transmit power for the ONU. In at least one example embodiment, the operating state may be, or include, one of compliance or non-compliance of the ONU relative to one or more standard operating parameters (e.g., a maximum and a minimum optical modulation amplitude (OMA) threshold value). In at least one other example embodiment, the operating state may be, or include, whether the ONU is malfunctioning or operating normally.

According to at least one example embodiment, a PPM may be optically tapped (connected) between the ONU and an OLT to identify the operating state of the ONU. The PPM may include, among other things, an internal optical switch or blocking element in the upstream path to isolate the connected ONU (e.g., that may be undergoing setup or testing) from the PON. While in isolation, the ONU may be placed in a test mode during which the PPM may obtain operating parameters (e.g., transmit power measurements, extinction ratio calculations, etc.) for determining an OMA level for the ONU.

According to at least some example embodiments, in the test mode the ONU may utilize a modified ranging scheme such that ranging “slots” or time intervals allow the PPM to perform (e.g., direct) measurement of optical transmission power of a test transmission sequence (also referred to as a sequence of optical power test transmissions or sequence of test transmission patterns) from the ONU.

In one example, the test transmission sequence may include:
A first optical transmission pattern including a first plurality of consecutive optical transmissions indicative of a first logic value (e.g., ALL 1's) during a time interval of length ‘x’;
A ‘NO POWER’ (blank) transmission during a time interval of length ‘a’ after expiration of the time interval of length ‘x’;
A second optical transmission pattern including a second plurality of consecutive optical transmissions indicative of a second logic value (e.g., ALL 0's) for a time interval of length ‘y’ after expiration of the time interval of length ‘a’;
A ‘NO POWER’ (blank) transmission during a time interval of length ‘b’ after expiration of the time interval of length ‘y’;
A third optical transmission pattern including a third plurality of consecutive optical transmissions indicative of alternating first and second logic values (e.g., nominal 50% data-stream, such as a pseudo-random bit sequence (PRBS), 101010 . . . , etc.) during a time interval of length ‘z’ after expiration of the time interval of length ‘a’; and
A ‘NO POWER’ (blank) transmission during a time interval of length ‘c’ time after expiration of the time interval of length ‘z’.

According to one or more example embodiments, the values of x, y, z, a, b, and c may be the same or different from one another. In one example, each of the values of x, y, z, a, b, or c may be less than or equal to about 1 second (e.g., between about 1 millisecond (ms) and about 10 ms). At least the values of each of x, y and z may be greater than the length of the Preamble transmission during normal operation.

The PPM may record transmission power measurements during the time intervals of length x, y and z, compute an extinction ratio for the ONU based on at least some of the measurements, and then compute an OMA level for the ONU based on the extinction ratio and an average transmit power for the ONU.

In one example, a training signal may be incorporated into the ONU and PPM to indicate to the PPM that the ONU has entered the test mode and that the test transmission sequence is to begin.

The ONU may automatically enter the test mode and initiate the test transmission sequence upon installation or initialization on a PON. In another example, the OLT may transmit a “special” command (e.g., power test or PowerTest command) to the ONU once the ONU has responded to a new ranging request from the OLT. In this case, the initial (or one of the initial) messages from the OLT to the ONU may be, for example, a “run test mode” command to put the ONU in the test mode and initiate the test transmission sequence. Multiple messages or a single message may be sent.

Although discussed herein with regard to a ‘NO POWER’ transmission between the respective optical transmission patterns, example embodiments should not be limited to this example. As an alternative, for example, the PPM and ONU may have knowledge of the length of the respective time intervals during which an optical transmission pattern is to be transmitted, and the ‘NO POWER’ transmission may be omitted. For example, the length of each respective time interval may be known a priori at the ONU and the PPM, or set by a network operator at the time the testing is performed.

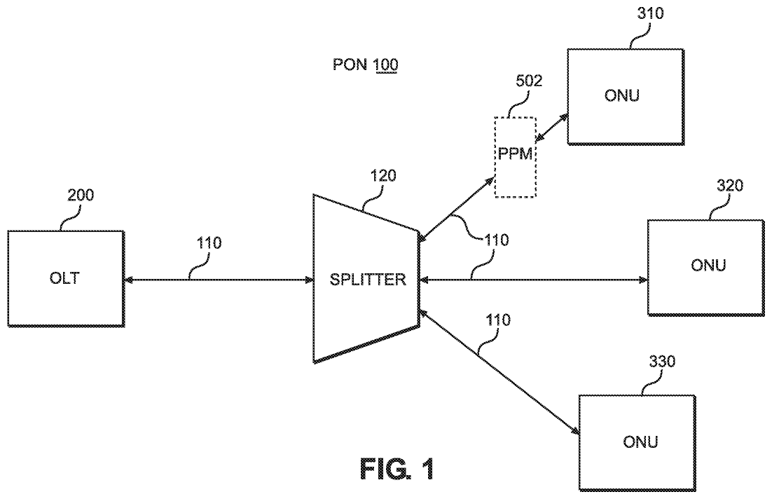

FIG. 1 is a block diagram illustrating an example PON.

Referring to FIG. 1, the PON 100 includes an OLT 200, a plurality of ONUs 310, 320, 330 and a passive splitter 120. The elements of the PON 100 shown in FIG. 1 are connected via several fiber optic cables 110. A PPM 502 is (temporarily) connected between the splitter 120 and the ONU 310.

Although only a single OLT 200, a single splitter 120, a single PPM 502 and three ONUs 310, 320, 330 are shown in FIG. 1, example embodiments should not be limited to this example.

In operation, the OLT 200 transmits a continuous data stream downstream to one or more of the ONUs 310, 320, 330, and one or more of the ONUs 310, 320, 330 transmits bursts of data upstream to the OLT 200. The splitter 120 is configured to split signals from the OLT 200 to the ONUs 310, 320, 330.

The PPM 502 is optically tapped (connected) between the ONU 310 and the splitter 120 and OLT 200 to, among other things, identify the operating state of the ONU 310. The PPM 502 may operate in a first (e.g., normal or passive) mode and a second (e.g., test or isolation mode).

In the normal mode, the PPM 502 passes upstream optical signals from the ONU 310 toward the OLT 200 while tapping a relatively small percentage (e.g., less than about 5%) of the upstream optical signals to perform measurements of operating parameters for upstream transmissions by the ONU 310. Also in the normal mode, the PPM 502 passes downstream optical signals from the OLT 200 to the ONU 310 while tapping a relatively small percentage of the downstream optical signals to perform measurements of operating parameters for downstream transmissions by the OLT 200.

In the test mode, the PPM 502 operates in the same manner with respect to downstream transmissions. In the upstream direction, however, the PPM 502 isolates the ONU 310 from the PON by blocking the upstream optical signals from passing through the PPM 502. The upstream optical signals are directed to an optical signal level meter to perform transmit power measurements of the upstream transmissions. The PPM 502 is then able to identify the operating state of the ONU 310 based on the transmit power measurements as will be discussed in more detail later.

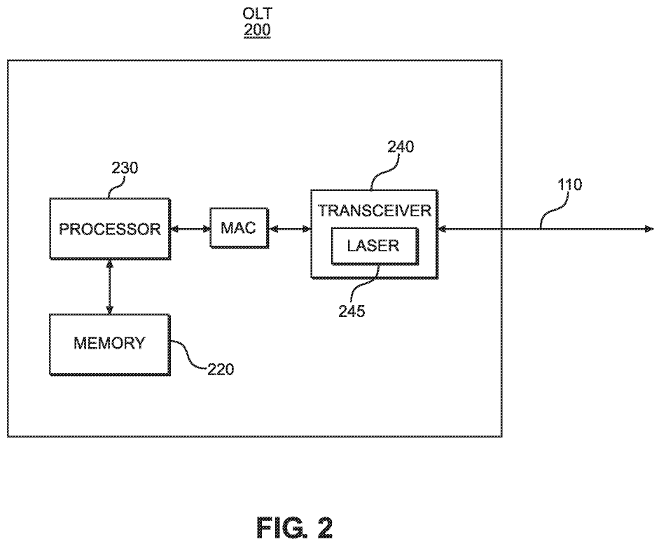

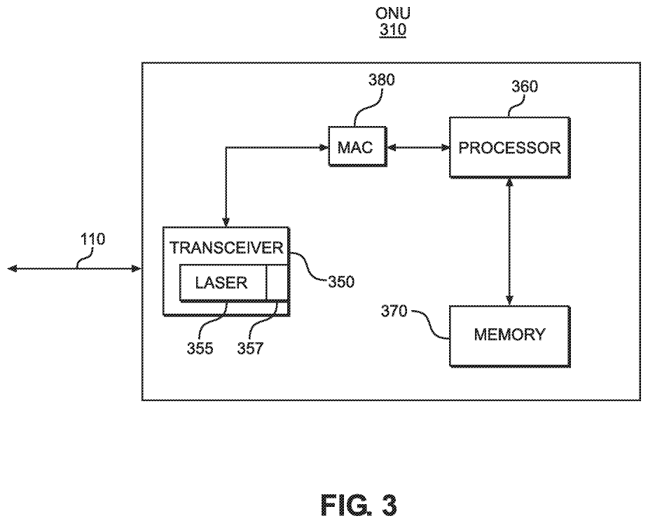

An example embodiment of each of the OLT 200, the ONU 310 and the PPM 502 will be discussed in more detail below with regard to FIGS. 2, 3 and 4, respectively. Although only an example embodiment of the ONU 310 will be discussed herein, it should be understood that each of ONUs 320 and 330 shown in FIG. 1 may be the same or substantially the same as the ONU 310 shown in FIG. 3.

FIG. 2 is a block diagram illustrating an example embodiment of the OLT 200.

Referring to FIG. 2, the OLT 200 includes a memory 220, a processor 230, a transceiver 240 and a media access controller (MAC) 250. The memory 220 stores computer readable instructions for operating the OLT 200. The memory 220 also stores one or more of information to be sent from the OLT 200, information received from one or more ONUs, measured or computed parameter values (e.g., transmit power, average transmit power, extinction ratio, Optical Modulation Amplitude (OMA), or the like), or a maximum and minimum OMA threshold value. The maximum and minimum OMA threshold values may be stored in the form of the following line entry in a lookup table. According to one or more example embodiments, the maximum and minimum OMA threshold values may be determined via empirical study and set by a network operator.
OLT: RSSI: OMA_{MIN} (dBm), OMA_{MAX} (dBm)

In one example, OMA_{MIN} may be about −24.2 dBm and OMA_{MAX} may be about −5.0 dBm.

The processor 230 controls the OLT 200, including the memory 220, the MAC 250 and the transceiver 240, based on instructions stored in the memory 220.

The transceiver 240 transmits and receives information via the fiber optic cable 110 to and from one or more of the ONUs 310, 320, 330 via the splitter 120. As shown in FIG. 2, the transceiver 240 includes a laser 245 to transmit information over the fiber optic cable 110. The MAC 250 may (directly) control the transceiver 240 based on instruction from the processor 230.

In at least one example embodiment, the transceiver 240 may be, or include, an OLT optical transceiver module (e.g., having an optical detector) configured to, among other things, perform CW signal measurement on the receiver path.

FIG. 3 is a block diagram illustrating an example embodiment of the ONU 310. As mentioned above, although only a detailed discussion of ONU 310 is provided, each of ONUs 320 and 330 shown in FIG. 1 may be the same or substantially the same as the ONU 310 shown in FIG. 3.

Referring to FIG. 3, the ONU 310 includes a memory 370, a processor 360, a MAC 380, and a transceiver 350.

The memory 370 stores computer readable instructions for operating the ONU 310. The memory 370 may also store one or more of information to be sent from the ONU 310, information received from the OLT 200, measured or computed parameter values (e.g., transmit power, average transmit power, extinction ratio, OMA, or the like), or the maximum and minimum OMA threshold value. The maximum and minimum OMA threshold values may be stored in the form of a line of entry in a lookup table in the same or substantially the same manner as discussed above with regard to FIG. 2.

The processor 360 controls the ONU 310, including the memory 370, the MAC 380, and the transceiver 350, based on the instructions stored in the memory 370. The processor 360 may also function as a counter to track, and identify expiration of, time intervals as will be discussed in more detail later.

The transceiver 350 transmits and receives information via the fiber optic cable 110 to and from the OLT 200. As shown in FIG. 3, the transceiver 350 includes a laser 355 to transmit information over the fiber optic cable 110. The MAC 380 (directly) controls the transceiver 350 based on instruction from the processor 360.

The laser 355 may optionally have a laser power control circuit 357 that controls the power output of the laser.

In at least one example embodiment, the transceiver 350 may be, or include, an OLT optical transceiver module (e.g., having an optical detector) configured to, among other things, perform CW signal measurement on the receiver path.

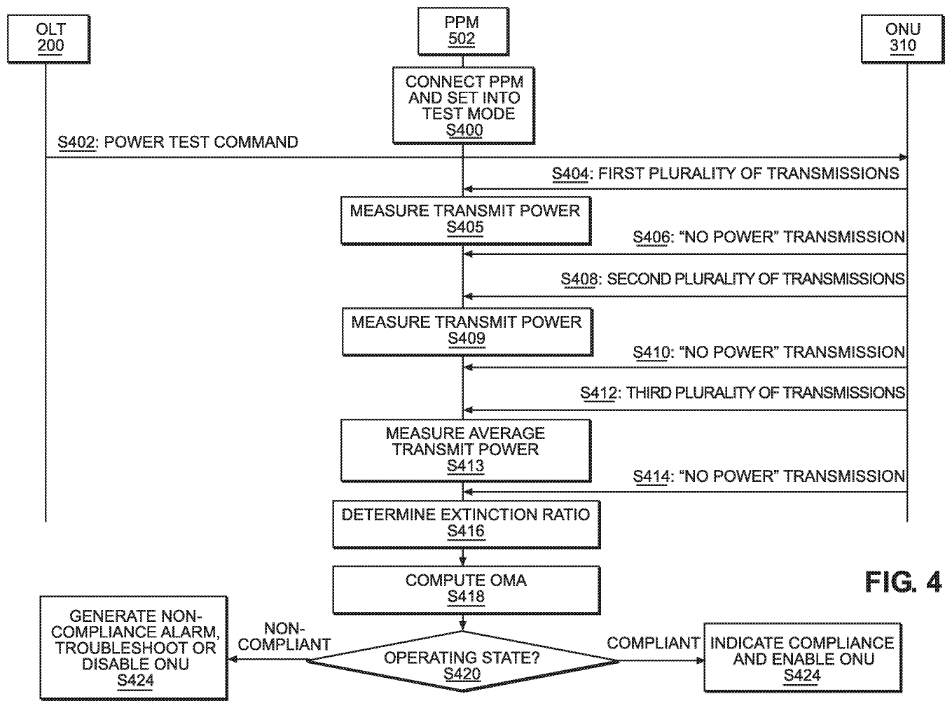

A more detailed discussion of example functionality of the ONU 310 will be provided later with regard to FIG. 4.

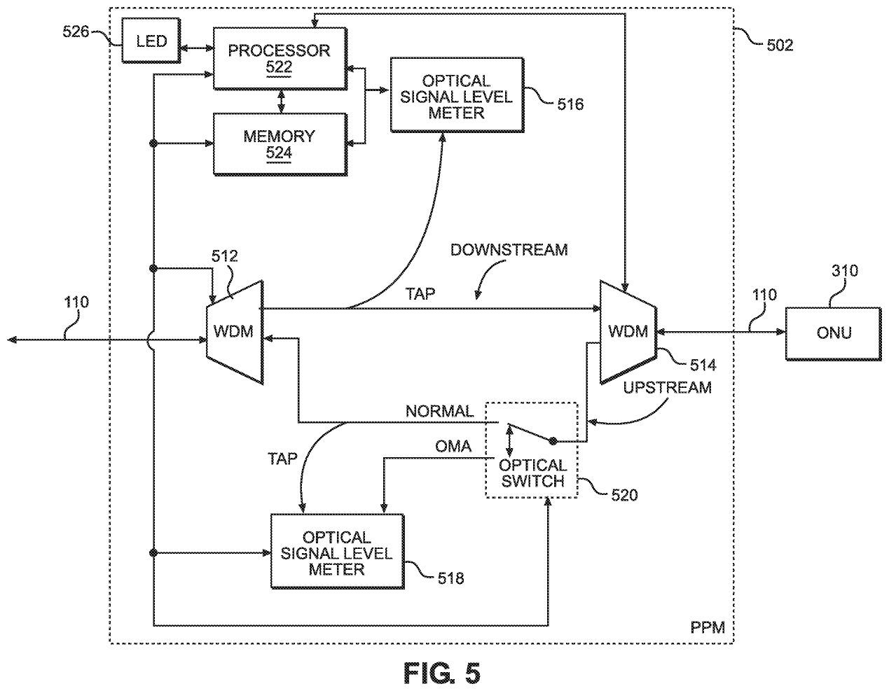

FIG. 5 is a block diagram illustrating an example embodiment of the PPM 502. As discussed above with regard to FIG. 1, the PPM 502 may be (e.g., temporarily) optically tapped or connected between an ONU 310 and the OLT 200 (or splitter 120).

Referring to FIG. 5, the PPM 502 includes a memory 524, a processor 522, downstream optical signal level meter 516, upstream optical signal level meter 518, wavelength division multiplexers/de-multiplexers (WDMs) 512 and 514, an optical switch 520 and one or more light emitting diodes (LEDs) 526. Although not shown in FIG. 5, each of the optical signal level meters 516 and 518 may include a light sensor (e.g., a photodetector or the like) and associated circuitry to convert received optical signals (transmissions) into electrical signals and then an optical transmit power of the optical signals.

The memory 524 stores computer readable instructions for operating the PPM 502. The memory 524 may also store one or more of information to be sent from the PPM 502, information received from the OLT 200 or the ONU 310, measured or computed parameter values (e.g., transmit power, average transmit power, extinction ratio, OMA, or the like), or the maximum and minimum OMA threshold value. The maximum and minimum OMA threshold values may be stored in the form of a line of entry in a lookup table in the same or substantially the same manner as discussed above with regard to FIGS. 2 and 3.

The processor 522 controls the PPM 502, including one or more of the memory 524, the optical signal level meters 516 and 518, WDMs 512 and 514, the optical switch 520 and the one or more LEDs 526, based on the instructions stored in the memory 524. The processor 522 may also function as a counter to track, and identify expiration of, time intervals as will be discussed in more detail later.

The WDMs 512 and 514 separate upstream and downstream optical signals received at the PPM 502 such that upstream optical signals from the ONU 310 traverse a physical optical path for upstream optical signals, and downstream optical signals from the OLT 200 traverse a separate physical optical path for downstream optical signals. Although shown as connected to the processor 522, the WDMs 512 and 514 may be fully passive devices that separate the upstream and downstream optical signals received at the PPM 502. In this case, the WDMs 512 and 514 need not be controlled by or connected to the processor 522.

On the downstream optical path, the PPM 502 optically taps a relatively small percentage of the optical signals for input to the optical signal level meter 516.

The optical signal level meter 516 measures transmit power or average transmit power of the tapped downstream signals as needed and outputs the measurements to the processor 522 (for processing) or memory 524 (for storing).

On the upstream optical path, the WDM 514 outputs the optical signals from the ONU 310 to the optical switch 520. The optical switch 520 may be any suitable optical switch having at least two channels.

According to at least some example embodiments, the optical switch 520 may operate in a normal (or passive) mode and a test (or isolation) mode. In the normal mode, the optical switch 520 directs the upstream optical signals to the WDM 512 via a first channel for output to the OLT 200 on the fiber optic cable 110. The PPM 502 optically taps a relatively small percentage of the upstream optical signals passing from the optical switch 520 to the WDM 512 for input to then optical signal level meter 518.

The optical signal level meter 518 measures transmit power or average transmit power of the tapped upstream optical signals and outputs the measurements to the processor 522 (for processing) or memory 524 (for storage).

In the test mode, the optical switch 520 isolates or blocks the upstream optical signals from being transmitted to the WDM 512 and fiber optic cable 110, thereby isolating the ONU 310 from the PON. Rather than being output to the WDM 512, in the test mode the optical switch 520 directs the upstream optical signals to the optical signal level meter 518 via a second channel. The optical signal level meter 518 measures transmit power or average transmit power of the upstream signals and outputs the measurements to the processor 522 or memory 524.

As will be discussed in more detail below with regard to FIG. 4, the PPM 502 determines an operating state (e.g., compliance, non-compliance, malfunction, etc.) of the ONU 310 based on the measured transmit power and average transmit power. The PPM 502 may then output an indication of the (current) operating state of the ONU 310 via visual, audio, haptic, a combination thereof, or any other suitable feedback. In one example, if the PPM 502 determines that the ONU 310 is in a compliant operating state, then the PPM 502 may cause one or more of the LEDs 526 to display a green indicator light. If the PPM 502 determines that the ONU 310 is in a non-compliant operating state, then the PPM 502 may cause one or more of the LEDs 526 to display a red indicator light.

Example functionality of the PPM 502 will be discussed in more detail below with regard to FIG. 4.

FIG. 4 is a hybrid signal flow diagram and flow chart illustrating a method according to example embodiments. For example purposes, the example embodiment shown in FIG. 4 will be discussed primarily with regard to the OLT 200, the PPM 502 and the ONU 310. Additionally, the example embodiment shown in FIG. 4 will be described for example purposes with regard to a specific sequence of transmission patterns (e.g., ALL 1's, then ALL 0's, then a nominal 50% data-stream, such as pseudo-random bit sequence (PRBS), 101010 . . . ). However, example embodiments should not be limited to this example. Rather, the sequence of transmission patterns may have any order or sequence as long as the sequence or order is known or agreed upon between the PPM 502 and ONU 310. In one example, the ONU 310 and PPM 502 may have a priori knowledge of the order of the transmission patterns. In another example, the OLT 200 may indicate an order of the transmission patterns to the PPM 502 and the ONU 310 in the power test command.

Referring to FIG. 4, at step S400 the PPM 502 is connected between the ONU 310 and the OLT 200, and set into the test mode. In one example, a network operator or technician may connect the PPM 502 between the ONU 310 and the OLT 200, and switch the PPM 502 from the normal mode to the test mode by changing the channel (e.g., from first channel to second channel) of the optical switch 520 such that the ONU 310 is isolated from the PON. The changing of the PPM 502 from the normal mode to the test mode (or vice versa) may be performed via a mechanical or software implemented switch.

At step S402, the OLT 200 sends a power test command to the ONU 310 to initiate the sequence of optical power test transmissions (test transmission sequence) by the ONU 310. In an example test scenario, the sending of the power test command by the OLT 200 may be initiated at the central office by a network operator or upon a ranging request due to installation of the ONU 310 on the PON. In other examples, the sending of the power test command by the OLT 200 may be initiated in response to detection of a fault or other issue (e.g., non-compliant BER) at the ONU 310 or be initiated in response to sensing that the PPM 502 has been connected to the PON and switched to the test mode. As mentioned above, the power test command may also indicate the order and timing of the sequence of transmission patterns by the ONU 310.

In response to the power test command, at step S404 the ONU 310 sends the first test transmission pattern in the sequence of test transmission patterns to the PPM 502 during a time interval of length ‘x’. In at least one example, the ONU 310 transmits a first plurality of consecutive optical transmissions indicative of a first logic value (e.g., ALL 1's) during the time interval of length ‘x’.

At step S405, the optical signal level meter 518 measures the transmit power P_{ALL_1s} of the first plurality of consecutive optical transmissions transmitted by the ONU 310 during the time interval of length ‘x’. For example, the optical signal level meter 518 converts the received optical transmissions into electrical signals and then into a transmit power P_{ALL 1s}. The optical signal level meter 518 stores the transmit power P_{ALL_1s} in, for example, the memory 524. According to one or more example embodiments, the first plurality of consecutive optical transmissions may be transmitted by the ONU 310 using a signal similar to traffic such that the optical signal level meter 518 may obtain a transmit power reading in Continuous Wave (CW) operating mode within the time interval of length ‘x’.

Upon determining that the time interval of length ‘x’ has expired, at step S406 the ONU 310 sends a first ‘NO POWER’ (blank) transmission to the PPM 502 during a time interval of length ‘a’ to indicate that the time interval of length ‘x’ has ended. This ‘NO POWER’ transmission may also indicate that a second test transmission pattern will be transmitted by the ONU 310 at the end of the interval of length ‘a’.

Upon expiration of the time interval of length ‘a’, at step S408 the ONU 310 sends the second test transmission pattern in the sequence of test transmission patterns to the PPM 502 during a time interval of length ‘y’. In more detail, for example, the ONU 310 transmits a second plurality of consecutive optical transmissions indicative of a second logic value (e.g., ALL 0's) during the time interval of length ‘y’.

At step S409, the optical signal level meter 518 measures the transmit power P_{ALL_0s} of the second plurality of consecutive optical transmissions transmitted by the ONU 310 during the time interval of length ‘y’. For example, the optical signal level meter 518 converts the received optical transmissions into electrical signals and then into a transmit power P_{ALL_0s}. The optical signal level meter 518 then stores the transmit power P_{ALL_0s} in, for example, the memory 524. According to one or more example embodiments, the second plurality of consecutive optical transmissions may be transmitted by the ONU 310 using a signal similar to traffic such that the optical signal level meter 518 may obtain a transmit power reading in CW operating mode within the time interval of length ‘y’.

Upon expiration of the time interval of length ‘y’, at step S410 the ONU 310 sends a second ‘NO POWER’ transmission to the PPM 502 during a time interval of length ‘b’ to indicate that the time interval of length ‘y’ has ended. This ‘NO POWER’ transmission may also indicate that a third test transmission pattern will be transmitted by the ONU 310 at the end of the interval of length ‘b’.

Upon expiration of the time interval of length ‘b’, at step S412 the ONU 310 sends the third test transmission pattern in the sequence of test transmission patterns to the PPM 502 during a time interval of length ‘z’. In at least one example, the ONU 310 transmits a third plurality of consecutive optical transmissions indicative of alternating first and second logic values (e.g., nominal 50% data-stream, such as PRBS, 101010 . . . ) during the time interval of length ‘z’.

At step S413, the optical signal level meter 518 measures the average transmit power P_{AVG} for the ONU 310 based on the third plurality of consecutive optical transmissions transmitted by the ONU 310 during the time interval of length ‘z’. For example, the optical signal level meter 518 converts the received optical transmissions into electrical signals and then into an average transmit power P_{AVG}. The optical signal level meter 518 then stores the average transmit power P_{AVG} in, for example, the memory 524. As with the first and second plurality of consecutive optical transmissions, the third plurality of consecutive optical transmissions may be transmitted by the ONU 310 using a signal similar to traffic such that the optical signal level meter 518 may obtain a transmit power reading in CW operating mode within the time interval of length ‘z’.

More generally, the operation at step S413 may be characterized as determining the average transmit power for the ONU 310 based on the third plurality of consecutive optical transmissions during the time interval of length ‘z’.

Upon expiration of the time interval of length ‘z’, at step S414 the ONU 310 sends a third ‘NO POWER’ transmission to the PPM 502 during a time interval of length ‘c’ to indicate that the time interval of length ‘z’ has ended.

At step S416, the PPM 502 determines the extinction ratio rₑ for the ONU 310 based on the stored transmit power P_{ALL_1s} for the first plurality of consecutive optical transmissions and the stored transmit power P_{ALL_0s} for the second plurality of consecutive optical transmissions. More specifically, for example, the PPM 502 may compute the extinction ratio rₑ for the ONU 310 according to Equation 1 shown below.

$${r}_{e} = \frac{{P}_{ALL \_ 1 s}}{{P}_{ALL \_ 0 s}} \qquad [ Equation 1 ]$$

The PPM 502 stores the computed extinction ratio rₑ in the memory 524.

More generally, the operation at step S416 may be characterized as determining the extinction ratio for the ONU 310 based on the first plurality of consecutive optical transmissions and the second plurality of consecutive optical transmissions.

At step S418, the PPM 502 computes an optical modulation amplitude (OMA) for the ONU 310 based on the extinction ratio rₑ determined at step S416 and the average transmit power P_{AVG} measured at step S413. The OMA is a mathematical relationship of average (or mean) output power and extinction ratio. In one example, the PPM 502 may compute the OMA based on the extinction ratio rₑ and the average transmit power Pave according to Equation 2 shown below.

$$OMA = 2 {P}_{AVG} \frac{{r}_{e} - 1}{{r}_{e} + 1} \qquad [ Equation 2 ]$$

At step S420, the PPM 502 determines an operating state (a current operating state) of the ONU 310 based on the OMA computed at step S418 and the maximum and minimum OMA threshold values (OMA_{MIN} and OMA_{MAX} stored in the memory 524. According to at least one example embodiment, the PPM 502 determines the operating state of the ONU 310 based on whether the computed OMA value is within the range between the minimum OMA threshold value OMA_{MIN} and the maximum OMA threshold value OMA_{MAX}. The operating state may be compliant or non-compliant, or malfunctioning or operating normally.

If the PPM 502 determines (e.g., through comparison) that the computed OMA value is less than the minimum OMA threshold value OMA_{MIN} or greater than the maximum OMA threshold value OMA_{MAX}, then the PPM 502 determines that the ONU 310 is non-compliant or malfunctioning at least from the perspective of optical transmission power. On the other hand, if the PPM 502 determines (e.g., through comparison) that the computed OMA value is within the range between the minimum OMA threshold value OMA_{MIN} and the maximum OMA threshold value OMA_{MAX}, then the PPM 502 determines that the ONU 310 is compliant or operating normally at least from the perspective of optical transmission power.

According to one or more example embodiments, non-compliance of the ONU may refer to the ONU failing to comply with one or more of a standardized average power, OMA threshold values or a specialized pass/fail criteria specified by a network operator or other user. Non-compliance of the ONU may be an indication that the ONU is malfunctioning. According to one or more example embodiments, malfunctioning of the ONU 310 may refer to a physical or logical failure or malfunction at the ONU or component thereof.

More generally, the operation at step S420 may be characterized as identifying the operating state of the ONU 310 based on the extinction ratio and the average transmit power.

Still referring to FIG. 4, if the PPM 502 determines that the operating state of the ONU 310 is non-compliant (or malfunction) at step S420, then at step S424 the PPM 502 generates a non-compliance alarm and may initiate troubleshooting or disabling of the ONU 310 at, for example, the OLT 200 or the central office. In at least one example embodiment, the non-compliance alarm may be in the form of audio, visual, haptic, a combination thereof, or any other suitable feedback. In one example, the PPM 502 may cause one or more of the LEDs 526 to flash red to indicate the non-compliance operating state. The PPM 502 may also output an alarm signal to the OLT 200 to indicate that the ONU 310 is non-compliant. In this case, the OLT 200 may generate an alarm towards the craft user interface or OSS in response to the alarm signal from the PPM 502.

According to one or more example embodiments, the troubleshooting or disabling of the ONU 310 may be performed by a technician at the ONU 310, by the OLT 200, at the central office or by a network operator.

In one example, the technician may disable the ONU 310 (take the ONU out-of-service) and repair or replace the unit as needed.

In another example, in response to the alarm signal from the PPM 502, if the OLT 200 or central office determines that the non-compliance of the ONU 310 is causing issues with other ONUs on the PON, then the OLT 200 (or central office) may send an out-of-service (00S) command to the ONU 310 to disable the ONU (take the ONU out-of-service).

In yet another example, if the non-compliance of the ONU 310 is not actually causing issues with other ONUs on the PON, then the ONU 310 may be tagged (e.g., by the OLT 200, central office or a network operator) for future replacement.

In still another example, in response to receiving the alarm signal from the PPM 502, the OLT 200 may troubleshoot the problem by initiating, or tagging the ONU 310 for, a remote restart at a convenient or designated time.

Returning to step S420, if the PPM 502 determines that the operating state of the ONU 310 is compliant (or normal), then the PPM 502 generates a compliance alarm. As with the non-compliance alarm, the compliance alarm may be in the form of audio, visual, haptic, a combination thereof or any other suitable feedback. In one example, the PPM 502 may cause one or more of the LEDs 526 to flash green to indicate the compliant operating state. In response to the indication that the ONU 310 is compliant, the ONU 310 may be put into service (e.g., by one or more of switching the optical switch to normal operation or removing the PPM 502 from the PON).

Although the example embodiment shown in FIG. 4 includes ‘NO POWER’ transmissions between the respective test transmission patterns, example embodiments should not be limited to this example. As an alternative, for example, the PPM 502 and ONU 310 may have knowledge of the length of the respective time intervals (e.g., through exchange of message(s) such as the power test command) during which the test transmission pattern is transmitted, and the ‘NO POWER’ transmissions may be omitted.

In the example embodiment shown in FIG. 4, the OLT 200 transmits a power test command to initiate the sequence of test transmissions by the ONU 310. However, example embodiments should not be limited to this example. According to at least some other example embodiments, the ONU 310 may self-initiate the power test sequence, an operator may cause the ONU 310 to initiate the power test sequence, or the PPM 502 may initiate the power test sequence (e.g., by sending a power test command to the ONU 310) upon being optically tapped on the PON or at the direction of a technician or network operator. In one example, the power test sequence may be initiated (e.g., by the ONU 310 or by an operator) upon being installed on the PON or being connected to a PPM.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing OLTs, ONUs, ONTs, PPMs, computers, central offices, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause an OLT, ONU, ONT, PPM, or the like to perform the necessary tasks. Additionally, the processor, memory, transceiver, MAC, etc., and example algorithms encoded as computer program code, may serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, OLTs, ONUs, ONTs, PPMs, computers, central offices, or the like may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

Reference is made in detail to embodiments, examples of which are illustrated in the accompanying drawings, wherein like reference numerals refer to the like elements throughout. In this regard, the example embodiments may have different forms and should not be construed as being limited to the descriptions set forth herein. Accordingly, the example embodiments are merely described below, by referring to the figures, to explain example embodiments of the present description. Aspects of various embodiments are specified in the claims.

What is claimed is:

1. A method of determining an operating state of an optical network unit, the method comprising:
determining, at a passive optical network power meter, an extinction ratio for the optical network unit based on a first plurality of consecutive optical transmissions indicative of a first logic value during a first time interval and a second plurality of consecutive optical transmissions indicative of a second logic value during a second time interval, the second time interval being subsequent to the first time interval;
detecting, at the passive optical network power meter, an average transmit power for the optical network unit based on a third plurality of consecutive optical transmissions during a third time interval, the third plurality of consecutive optical transmissions indicative of alternating first and second logic values; and
identifying, at the passive optical network power meter, an operating state of the optical network unit based on the extinction ratio and the average transmit power.

2. The method of claim 1, wherein the operating state of the optical network unit is one of compliant or non-compliant relative to standard operating parameters associated with the optical network unit.

3. The method of claim 2, wherein
the standard operating parameters include a maximum optical modulation amplitude threshold value and a minimum optical modulation amplitude threshold value for the optical network unit;
the method further includes computing an optical modulation amplitude value for the optical network unit based on the extinction ratio and the average transmit power; and
the identifying identifies the operating state of the optical network unit based on the optical modulation amplitude value, the minimum optical modulation amplitude threshold value and the maximum optical modulation amplitude threshold value.

4. The method of claim 3, wherein the identifying identifies the operating state of the optical network unit based on whether the optical modulation amplitude value is between the minimum optical modulation amplitude threshold value and the maximum optical modulation amplitude threshold value.

5. The method of claim 1, wherein the determining, the detecting and the identifying are performed at the time of installation of the optical network unit at a subscriber premises.

6. The method of claim 1, wherein
the first time interval is temporally spaced apart from the second time interval by a fourth time interval; and
the method further includes receiving a NO POWER transmission at the passive optical network power meter during the fourth time interval.

7. The method of claim 1, further comprising:
isolating, by the passive optical network power meter, the optical network unit from a passive optical network in the upstream direction.

8. The method of claim 7, wherein the isolating comprises:
directing the first plurality of consecutive optical transmissions from the optical network unit to an optical signal level meter;
measuring a first transmit power of the first plurality of consecutive optical transmissions from the optical network unit;
directing the second plurality of consecutive optical transmissions from the optical network unit to the optical signal level meter;
measuring a second transmit power of the second plurality of consecutive optical transmissions from the optical network unit;
directing the third plurality of consecutive optical transmissions from the optical network unit to the optical signal level meter for detecting the average transmit power for the optical network unit; and wherein
the determining determines the extinction ratio based on the first transmit power and the second transmit power.

9. A passive optical network power meter comprising:
at least one processor; and
at least one memory including computer program code, the at least one memory and the computer program code configured to, with the at least one processor, cause the passive optical network power meter to
determine an extinction ratio for an optical network unit based on a first plurality of consecutive optical transmissions indicative of a first logic value during a first time interval and a second plurality of consecutive optical transmissions indicative of a second logic value during a second time interval, the second time interval being subsequent to the first time interval,
detect an average transmit power for the optical network unit based on a third plurality of consecutive optical transmissions during a third time interval, the third plurality of consecutive optical transmissions indicative of alternating first and second logic values, and
identify an operating state of the optical network unit based on the extinction ratio and the average transmit power.

10. The passive optical network power meter of claim 9, wherein the operating state of the optical network unit is one of compliant or non-compliant relative to standard operating parameters associated with the optical network unit;
the standard operating parameters include at least a maximum optical modulation amplitude threshold value and a minimum optical modulation amplitude threshold value for the optical network unit; and
the at least one memory and the computer program code are configured to, with the at least one processor, cause the passive optical network power meter to
compute an optical modulation amplitude value for the optical network unit based on the extinction ratio and the average transmit power, and
identify the operating state of the optical network unit based on the optical modulation amplitude value, the minimum optical modulation amplitude threshold value and the maximum optical modulation amplitude threshold value.

11. The passive optical network power meter of claim 10, wherein the at least one memory and the computer program code are configured to, with the at least one processor, cause the passive optical network power meter to identify the operating state of the optical network unit based on whether the optical modulation amplitude value is between the minimum optical modulation amplitude threshold value and the maximum optical modulation amplitude threshold value.

12. The passive optical network power meter of claim 9, further comprising:
an optical switch configured to isolate the optical network unit from a passive optical network in the upstream direction.

13. The passive optical network power meter of claim 12, further comprising:
an optical signal level meter configured to measure a first transmit power of the first plurality of consecutive optical transmissions, a second transmit power of the second plurality of consecutive optical transmissions, and to detect the average transmit power for the optical network unit; wherein
the optical switch is configured to direct the first plurality of consecutive optical transmissions, the second plurality of consecutive optical transmissions and the third plurality of consecutive optical transmissions to the optical signal level meter, and
the at least one memory and the computer program code are configured to, with the at least one processor, cause the passive optical network power meter to determine the extinction ratio based on the first transmit power and the second transmit power.

14. The passive optical network power meter of claim 9, wherein
the passive optical network power meter is configured to operate in a passive mode and an isolation mode; and
the passive optical network power meter includes an optical switch, the optical switch configured to
pass transmission signals from the optical network unit in the upstream direction when in the passive mode, and
block transmission signals from the optical network unit in the upstream direction when in the isolation mode.

15. A non-transitory computer-readable storage medium storing computer-readable instructions that, when executed by at least one processor, cause a passive optical network power meter to perform a method of determining an operating state of an optical network unit, the method comprising:
determining an extinction ratio for the optical network unit based on a first plurality of consecutive optical transmissions indicative of a first logic value during a first time interval and a second plurality of consecutive optical transmissions indicative of a second logic value during a second time interval, the second time interval being subsequent to the first time interval;
detecting an average transmit power for the optical network unit based on a third plurality of consecutive optical transmissions during a third time interval, the third plurality of consecutive optical transmissions indicative of alternating first and second logic values; and
identifying an operating state of the optical network unit based on the extinction ratio and the average transmit power.

16. The non-transitory computer-readable storage medium of claim 15, wherein the operating state of the optical network unit is one of compliant or non-compliant relative to standard operating parameters associated with the optical network unit.

17. The non-transitory computer-readable storage medium of claim 16, wherein
the standard operating parameters include a maximum optical modulation amplitude threshold value and a minimum optical modulation amplitude threshold value for the optical network unit;
the method further includes computing an optical modulation amplitude value for the optical network unit based on the extinction ratio and the average transmit power; and
the identifying identifies the operating state of the optical network unit based on the optical modulation amplitude value, the minimum optical modulation amplitude threshold value and the maximum optical modulation amplitude threshold value.

18. The non-transitory computer-readable storage medium of claim 17, wherein the identifying identifies the operating state of the optical network unit based on whether the optical modulation amplitude value is between the minimum optical modulation amplitude threshold value and the maximum optical modulation amplitude threshold value.

19. The non-transitory computer-readable storage medium of claim 15, wherein
isolating the optical network unit from a passive optical network in the upstream direction.

20. The non-transitory computer-readable storage medium of claim 19, wherein the isolating comprises:
directing the first plurality of consecutive optical transmissions from the optical network unit to an optical signal level meter;
measuring a first transmit power of the first plurality of consecutive optical transmissions from the optical network unit;
directing the second plurality of consecutive optical transmissions from the optical network unit to the optical signal level meter;
measuring a second transmit power of the second plurality of consecutive optical transmissions from the optical network unit;
directing the third plurality of consecutive optical transmissions from the optical network unit to the optical signal level meter for detecting the average transmit power for the optical network unit; and wherein
the determining determines the extinction ratio based on the first transmit power and the second transmit power.
